(19) United States
(12) Patent Application Publication
(10) Pub. No.: US 2017/0024735 A1
(43) Pub. Date: Jan. 26, 2017

(54) SYSTEM AND METHOD FOR STORED VALUE CARD EXCHANGE

(71) Applicant: JPMorgan Chase Bank, N.A., (US)

(72) Inventor: John Mitsuru KAWAUCHI, Dublin, OH (US)

(73) Assignee: JPMorgan Chase Bank, N.A., New York, NY (US)

(21) Appl. No.: 13/626,084

(22) Filed: Sep. 25, 2012

(51) Int. Cl. G06Q 20/28; G06Q 40/02

(52) U.S. Cl. CPC G06Q 20/403

(57) ABSTRACT

A system and method for allowing a financial institution customer or user to exchange a stored value card, such as, for example, a gift card, for its value in currency or other value, such as rewards points, is provided. The resulting value from the exchange can then be deposited in a financial account, at the financial institution, of the customer's choosing. Following the exchange for value, the stored value card is cancelled to prevent subsequent use by the customer. The method may be performed on-line through the financial institution's website or mobile application, at an Automated Teller Machine (“ATM”), a financial transaction machine or device, or at a branch location of the financial institution. The physical card may not be required for the exchange. However, the data associated with the card, such as the account number, is required for entry by the customer into an appropriate interface.

### FIELD OF THE INVENTION

The invention relates generally to providing financial services in the context of stored value cards and the like and the exchange thereof of the card for its determined value in currency or the like.

### BACKGROUND OF THE INVENTION

Pre-paid cards., which include gift cards, are a form of stored value cards. These cards are widely used in commerce. However, there is not an efficient system that exists for exchanging the card for a value in currency which can then be directly deposited into an account of the holder's choosing

These and other deficiencies exist.

### SUMMARY OF THE INVENTION

Exemplary embodiments include a computer implemented method. The method includes receiving, electronically, a request, from a customer of a financial institution, to exchange a pre-paid card for funds corresponding to a determined value of the pre-paid card; receiving from the customer data relating to the pre-paid card; processing, by at least one computer processor, the request; providing, electronically, an offer to the customer containing the determined value, receiving an acceptance of the offer from the customer; and providing the determined value to the customer by depositing the determined value into an account designated by the customer.

Exemplary embodiments include a system. The system includes: a processor; and a memory comprising computer-readable instructions which when executed by the processor cause the processor to perform the following steps: receive a request, from a customer of a financial institution, to exchange a pre-paid card for funds corresponding to a determined value of the pre-paid card; receive from the customer data relating to the pre-paid card; process the request; provide an offer to the customer containing the determined value, receive an acceptance of the offer from the customer; and provide the determined value to the customer by depositing the determined value into an account designated by the customer.

Exemplary embodiments include a computer implemented method. The method includes: receiving, electronically, a transaction request, from a first merchant to use a pre-paid card for a transaction wherein the pre-paid card is from a second merchant and the pre-paid card is presented for the transaction by a customer of a financial institution; receiving data relating to the pre-paid card; processing, by at least one computer processor, the data; providing, electronically, an offer to the customer, through a merchant terminal, containing a determined value of the pre-paid card with regards to the transaction; receiving an acceptance of the offer; and applying the determined value against an amount of the transaction.

Exemplary embodiments include a system. The system includes: a processor, and a memory comprising computer-readable instructions which when executed by the processor cause the processor to perform the following steps: receiving, electronically, a transaction request, from a first merchant to use a pre-paid card for a transaction wherein the pre-paid card is from a second merchant and the pre-paid card is presented for the transaction by a customer of a financial institution; receiving data relating to the pre-paid card; processing, by at least one computer processor, the data; providing, electronically, an offer to the customer, through a merchant terminal, containing a determined value of the pre-paid card with regards to the transaction; receiving an acceptance of the offer; and apply Mg the determined value against an amount of the transaction.

These and other embodiments and advantages of the invention will become apparent from the following detailed description, taken in conjunction with the accompanying drawings, illustrating by way of example the principles of the various exemplary embodiments.

### BRIEF DESCRIPTION OF THE DRAWINGS

For the purposes of illustrating exemplary embodiments, there is shown in the drawings a form which is presently preferred, it being understood however, that the embodiments are not limited to the precise form shown by the drawing in which:

FIG. 1 is a flow chart of a method according to exemplary embodiments.

FIG. 2 is a depiction of a system according to exemplary embodiments

FIG. 3 is a flow chart of a method according to exemplary embodiments.

### DETAILED DESCRIPTION OF THE PREFERRED EMBODIMENTS

It will be readily understood by those persons skilled in the art that the embodiments of the inventions described herein are capable of broad utility and application.

Accordingly, while the invention is described herein in detail in relation to the exemplary embodiments, it is to be understood that this disclosure is illustrative and exemplary of embodiments of the invention and is made to provide an enabling disclosure of the invention. Accordingly, the disclosure is not intended to be construed to limit the embodiments of the invention or otherwise to exclude any other such embodiments, adaptations, variations, modifications and equivalent arrangements. While the various embodiments of the present invention are described in the context of financial service relating generally to stored value cards, the methods and systems described herein may be applied to other related services involving interaction with financial institutions or merchants involving such cards.

The following descriptions are provided of different configurations and features according to exemplary embodiments. These configurations and features may relate to providing financial services in the context of stored value cards. While certain nomenclature and types of applications/hardware are described, other names and application/hardware usage is possible and the nomenclature provided is done so by way of non-limiting examples only. Further while particular embodiments are described, it should be appreciated that the features and functions of each embodiment may be combined in any combination as is within the capability of one of ordinary skill in the art. The attached Figures provide additional details regarding the present invention. It should also be appreciated that these exemplary embodiments are provided as non-limiting examples only.

The use of particular terms “stored value card,” “gift card,” or “pre-paid card,” as used herein is meant to be non-limiting and exemplary.

A stored value card, gift card, or pre-paid card may have a physical form factor similar to or the same as that of a typical credit card These cards may be a sticker or have other form factors, such as a key fob or dongle. The cards may have a magnetic stripe associated therewith. For example, a pre-paid card may have a magnetic stripe on one side of the card. In some embodiments, the card may have Radio Frequency Identification (RFID) or Near Field Communications (NFC) capability. A smart chip may embedded therein the card. The stored value card may have a combination of the preceding elements. For example, a stored value card may have a magnetic strip and a smart chip and NFC or RFID capability. Other combinations are possible. The stored value card may have information embossed or engraved thereon. The stored value card may be personalized. For example, the stored value card may have the cardholder's name thereon.

In some embodiments, the stored value card may be a virtual or electronic card. The virtual card may be stored on a computing device or in the cloud to be accessed by a computing device. The computing device may be a portable electronic device. For example, the computing device may be a smart phone or tablet computing device. The stored value card may have both virtual and a physical embodiments.

The stored value card may have card data associated therewith. For example, the card data may include an account number, an expiration date, a payment network, a card sponsor, a value, and a card type. In some embodiments, the card data may include the name of a specific merchant. It should be appreciated that the stored value card may have additional data associated therewith.

The stored value card may be configured for use at a particular merchant only. For example, a gift card may be issued by a particular merchant and that stored value can only be used for transactions at that particular merchant. Some stored value cards may be usable at more than one merchant. For example, a pre-paid card may be usable at more than one merchant, in some embodiments, the stored value card may be usable at a plurality merchants without restriction. For example, debit cards and pre-paid cards may be usable at whatever merchants accept the transaction network that the card is associated with.

Exemplary embodiments provide a system and method for allowing a financial institution customer or user to exchange a stored value card, such as, for example, a gift card, for its value in currency. Exchange to other forms of value, such as reward points or miles may be possible in lieu of, in addition to (such as in combination with) the currency value. The resulting value from the exchange can then be deposited in a financial account, at the financial institution, of the customer's choosing. In the case of reward points or miles, the deposit may be into a rewards account. Following the exchange for value, the stored value card is cancelled to prevent subsequent use by the customer. The method may be performed on-line through the financial institution's website or mobile application, at an Automated Teller Machine (“ATM”), a financial transaction machine or device, or at a branch location of the financial institution. The physical card may not be required for the exchange However, the data associated with the card, such as the account number, is required for entry by the customer into an appropriate interface. In some embodiments, surrender or destruction of the physical card may be required.

To use the method described herein, the user must be a customer of the financial Institution. Being a customer may require having one or more accounts or services with the financial institution. Accordingly, because the customer's identity is known and fraud prevention measures can be implemented. Furthermore, a third party may be a part of the method. The third party may provide the valuation of the stored value card. The third party may then pay or otherwise transact with the financial institution to purchase the exchanged stored value card.

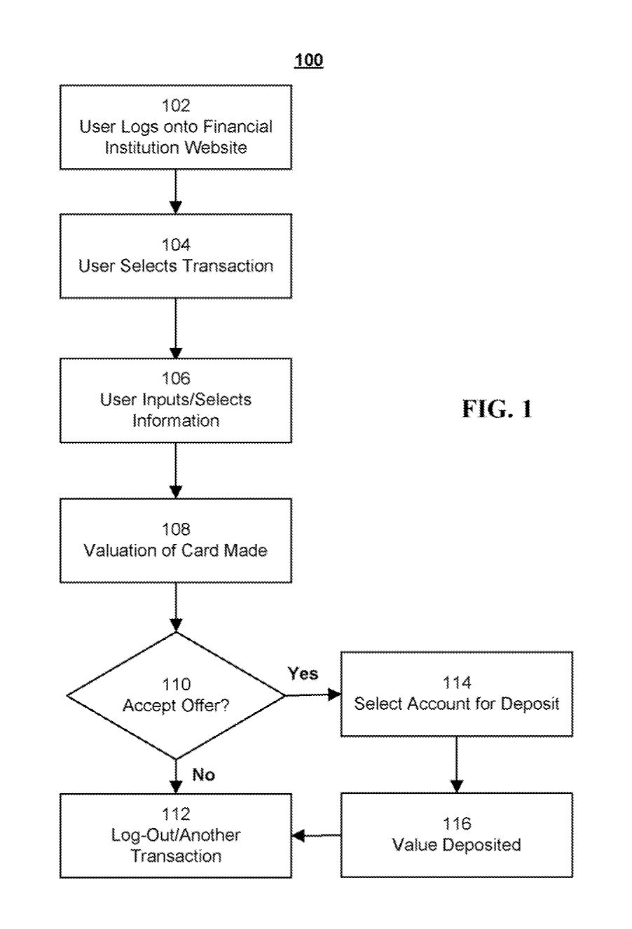

FIG. 1 depicts a flow chart of a method of exchanging a stored value card according to exemplary embodiments of the in. Exemplary method 100 is provided by way of example, as there are a variety of ways to carry out the methods disclosed herein The method 100 may be executed or otherwise performed by one or a combination of various systems, such as a computer implemented system. Each block shown in FIG. 1 represents one or more processes, methods, and/or subroutines carried out in the exemplary method 100. Each block may have an associated processing machine or the blocks depicted may be carried out through one processor machine.

The method 100, according to exemplary embodiments, may be carried out on-line, that is, through a website over the internet. It should be appreciated that other computer based networks may be used. For example, the method 100 may be carried out through a website over a computer based network associated with a financial institution

At block 102, a user logs into a website. The website is associated with a financial institution. For example, the website may be the website, portal, or mobile application through which a customer can interact with and conduct transactions with the financial institution. The log-on may require a username and password, it should be appreciated that other log-on techniques may be used, such as abbreviated log-in procedures for returning users, card based log-in and biometrics. Through the log-on process, the user's identity may be verified by the financial institution. The user's identity may then be confirmed as a customer of the financial institution The user may be a customer because they have one or more accounts with the financial institution or have an established relationship with the financial institution.

At block 104, the user selects the card exchange transaction The user may select the transaction from a menu or other graphical user interface. The selection of the transaction type may commence the process. The card exchange may be for the exchange of one or more stored value cards, gift cards, and/or pre-paid cards for an equivalent value in currency (or other types of value as described above).

At block 106, the user is requested to input and/or select information related to the transaction. This information is required for completion of the exchange. The information, once input and/or selected, may then be transmitted to the financial institution for further processing. The information may be transmitted to a third party. In some embodiments, the information may be transmitted to both the financial institution and the third party. The information may be processed by the financial institution prior to transmission to the third party. In some embodiments, multiple third parties may be involved. For example, the information may be transmitted to more than one third party. The initial processing of the information may include a determination of the validity of the card. If the card is determined to not be valid, then the customer may be so informed and the transaction for the exchange terminated.

The information requested relates to the card desired to be exchanged. The information may be requested to be entered by the user into a form. The form may have appropriate prompts for the user, including identifying required information. In some embodiments, the user may select information from one of more menus or other graphical user interfaces. For example, pull-down type lists may be used to allow the user to select information from a set of predetermined choices. A combination of entry methods may be used. For example, the user may both enter information and select information from menus.

The information required may be the card type, card name, card account number, and expiration date. This information is exemplary and other information may be required. Because the user is entering the information into a website, the physical card may not be required, only the information pertaining to the card.

In some embodiments, a card associated with a bankrupt or otherwise defunct merchant or other entity may be accepted as valid and honored for value exchange by the financial institution. In such situations, the financial institution may have an agreement to honor the cards from the entity and provide for their exchange into another value form so that the value of the card is not lost.

At block 108, a value determination of the card is made. The value determination is the value the user will receive for the card exchange. The value may be determined by the financial institution or by a third party. A combination of both may determine the value. The value may be based upon an exchange rate. The exchange rate may be fixed or variable. For example, the card may have $50 of value which is exchanged at a 1:1 rate. Thus, the user would get $50 in the exchange. The exchange rate may be higher or lower than one. The exchange rate may be based on the type of currency associated with the card or the currency the exchange is being made for.

In some embodiments, the value determination may be made by a number of Parties. Thus, more than one value determination may be made by the number of parties. The parties may be associated with or predetermined by the financial institution as participating in the method described herein. Different exchange rates may be used. For example, the each of the number of parties may produce a value determination. In this case of more than one value determination, the financial institution may receive these different value determinations. The financial institution may then evaluate the value determinations and determine which one to present as the offer to the user. The financial institution may use different criteria to assess which one to present. For example, the value determination using the most favorable exchange rate may be used as the offer. Thus, this embodiment may be able to find the “best” offer to make to the user. This process of evaluating the value determinations may be done automatically using a computer which has a set of rules programmed to make the determination. The rules may be changed or updated as needed by the financial institution.

At block 110, the user makes a decision to accept the offer. The offer, which is the value determination, is presented to the user. The user can make a decision on whether to accept the offer. The user may be presented with a total value the ill receive from the exchange. The exchange rate may be displayed for the customer. The user may be presented with multiple offers as described above. The user may be presented with offers to convert the card value to different currency types. For example, the user may receive offers to convert to dollars reward points, airline miles, and/or foreign currency. As a part of acceptance of the value, the card is cancelled. In this manner, further use of the card is prevented. The financial institution may notify the appropriate entity or third party of the exchange of the card to facilitate the cancellation thereof. In some embodiments, the user may be requested to destroy the card.

If the user declines the offer, at block 112 the user may log-out of the website or conduct another transaction. The other transaction may be another exchange or a separate, unrelated transaction.

If the user accepts the offer, at block 114 the user selects an account into which to deposit the value. For example, the user may select a checking account into which the value is deposited.

At block 116, the value is deposited into the selected account. In some embodiments, the customer may receive a debit or stored value card, issued by the financial institution, with the received value stored thereon. Following the deposit, the customer may receive a receipt for the transaction. The receipt may be issued electronically. The customer may be able to select multiple accounts to receive the value and split the value into portions to be deposited into each selected account.

In some embodiments, the method may be conducted at a branch location of the financial institution or an ATM. In such locations, the method may be similar to that described above. However, the physical or electronic version of the card may be used for the input of the card data. For example, at a branch location, the card may swiped or dipped or otherwise used with a reader which reads the card data. ATM's and financial transaction devices may have similar functionality for reading card data. It should be appreciated, that in such cases, the user may still enter the card data. Card data from electronic cards may be extracted in a similar manner. For example, the user may have a virtual card on their portable electronic device. The branch location or ATM may have an appropriate interface, such as a Near Field Communications terminal, for reading this card data. In some embodiments, a bar code or QR code or other digital image may used for transmitting/reading the card data.

In some embodiments, the customer may designate a third party as the recipient of the funds from the card. For example, the customer may designate another person's account for the value, i.e., the funds, to be deposited into. More than one third party may receive a portion of the value. Furthermore, the customer may transfer the value to another gift card. In this embodiment, the customer may exchange one gift card and receive the value. The customer may then request the value be placed onto a second gift or pre-paid card. The financial institution may have agreements with certain entities to enable this process to be performed. The types of gift cards or pre-paid card that this transfer of value may be performed with may be limited. In order to perform the transfer, the customer may need to supply the card data associated with the second card. In some embodiments, the second card may be a new card. In some embodiments, the second card may be a preexisting card.

In some embodiments, the customer may receive the card value in points, such as reward points, instead of currency. The reward points may then be deposited into a reward account associated with the customer. The customer may designate the reward account. The rewards account may be associated with a third party. The customer may designate multiple rewards accounts to each receive a designated portion of the value.

For fraud prevention purposes, the financial institution may reserve the right to recoup the amount the customer received from the exchange. The financial institution may limit the number of cards or value to be exchanged in a single transaction or time period The financial institution may require the customer to maintain a certain minimum balance in the account to cover potential recoupment of the value in the event the transaction is found to be fraudulent. For example, the customer may conduct an exchange for one or more cards. The customer may receive the value. The financial institution may find out that fraud was committed involving the card, such as the card being used immediately following the exchange before it was cancelled. The financial institution may then recoup the value deposited in the customer's account(s).

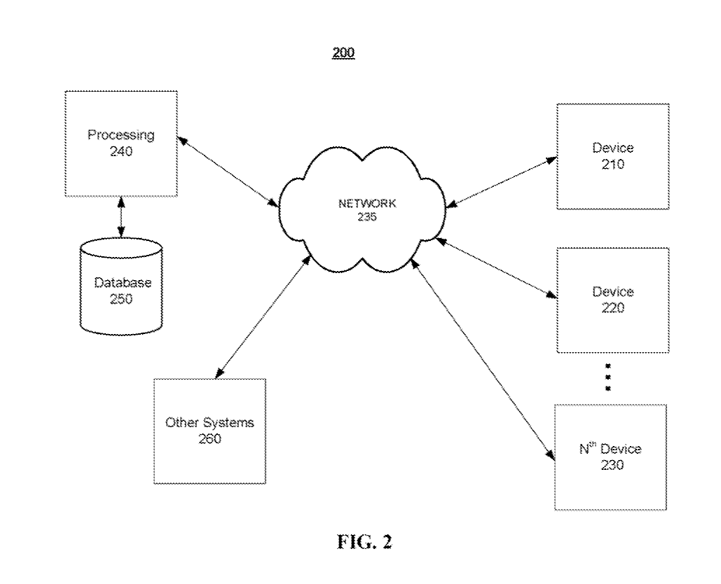

FIG. 2 is a system according to an exemplary embodiment of the invention. System 200 may provide various functionality and features associated with the program. While a single illustrative block, module or component is shown, these illustrative blocks, modules or components may be multiplied for various applications or different application environments. In addition, the modules or components may be further combined into a consolidated unit. The modules and/or components may be further duplicated, combined and/or separated across multiple systems at local and/or remote locations. For example, some of the module, or functionality associated with the modules may be supported by a separate application or platform. Other implementations and architectures may be realized. It should be appreciated that system 200 may be integrated into and run on a computer, which may include a programmed processing machine which has one or more processors. Such a processing machine may execute instructions stored in a memory to process the data. System 200 may be integrated into and run on one or more computer networks which may each have one of more computers associated therewith.

System 200 may include a device 210, a second device 220, and an Nth device 230, a network 235, a processing module 240, a database 250, and other systems 260, 10043j As noted above, the processing machine executes the instructions that are stored in the memory or memories or persistent or non-transitory data storage devices to process data. This processing of data may be in response to commands by a user or users of the processing machine, in response to previous processing, in response to a request by another processing machine and/or any other input, for example. As described herein, a module performing functionality may have a processor.

According to exemplary embodiments, the system 200 may be configured to carry out the methods as described herein. The system 200 may have device 210 associated therewith. A second device 220 and an Nth device 230 may be further associated with the system 200. The devices 210, 220, and 230 may each be a processing machine. Each device 210, 220, and 230 may include software and/or modules to implement the methods described herein according to exemplary embodiments. Each device 210, 220, and 230 may provide processing, display, storage, communications, and execution of commands in response to inputs from a user thereof and respond to requests from the software and/or modules.

The devices 210, 220, and 230 may each represent computer terminals, communicatively coupled to the network 235, as shown. These computer terminals may be associated with or used by the users in the method described in FIG. 1, for example

The devices 210, 220, and 230 may be configured to perform other functions and processing beyond the methods described herein. The devices 210, 220, and 230 may be multi-functional in operation. In some embodiments, the devices 210, 220, and 230 may be a portable or hand-held computing or electronic device, or other type of computing device, that has the described functionality. For example, the devices 210, 220, and 230 may be a tablet computing device. The portable electronic de ices by way of non-limiting examples, may include such hand-held/portable computing and communications devices as mobile phones (e.g., cell or cellular phones), smart phones (e.g., iPhones, Android based phones, or Blackberry devices), personal digital assistants (PDAs) (e.g., Palm devices), laptops, netbooks, tablets, or other portable computing devices. These portable electronic devices may communicate and/or transmit/receive data over a wireless signal. The wireless signal may consist of Bluetooth, Wireless Application Protocol (WAP), Multimedia Messaging Service (MMS), Enhanced Messaging Service (EMS), Short Message Service (SMS), Global System for Mobile Communications (GSM) based systems, Code Division Multiple Access (CDMA) based systems, Transmission Control Protocol/Internet (TCP/IP) Protocols, or other protocols and/or systems suitable for transmitting and receiving data from the portable electronic device. The portable electronic device may use standard wireless protocols which may include IEEE 802.11a, 802.11b. 802.11g, and 802.11n. Such portable electronic devices may be Global Positioning System (GPS) capable. GPS is a satellite based system which sends a signal allowing a device to define its approximate position in a coordinate system on the earth. That is, the portable electronic device may receive satellite positioning data and display the location on the earth of the portable electronic device using GPS. Other location systems may be used. The portable electronic device may include one or more computer processors and be capable of being programmed to execute certain tasks.

Each device 210, 220, and 230 may have a display and an input device associated therewith. The display may be monochrome or color. For example, the display may be a plasma, liquid crystal, or cathode ray tube type display. The displays may be touch screen type displays. The devices 210, 220, and 230 may have more than one display.

The input device may be a single device or a combination of input devices. For example, the input devices may include a keyboard, both full-sized QWERTY and condensed, a numeric pad, an alpha-numeric pad, a track ball, a touch pad, a mouse, selection buttons, and/or a touch screen. As described above, the display may serve as an input device through using or incorporating a touch screen interface The devices 210, 220, and 230 may include other devices such as a printer.

According to some embodiments, the devices 210, 220, and 230 may be financial services devices as described herein. The financial services device may be a transaction device for conducting transactions with the financial institution. For example, the devices 210, 220, and 230 may be a traditional or typical ATM. The devices 210, 220, and 230 may be financial services kiosks.

Network 235 may be a computer based network, with one or more servers and/or computer processors. For example, network 235 may be the Internet or a network connected to the Internet. The network 235 may be a satellite or cellular based network. Information and data may be exchanged through the network 235 between the various components of the system 200. In alternative embodiments, the network 235 may be a local area network within the financial institution that may be connected to or interface with the Internet. It should be appreciated that the network 235 may be a combination of local area networks, wide area networks, and external networks, which may be connected to the Internet.

The processing module 240 may be communicatively coupled to the network 235. The processing module 240 may perform operations associated with the method described herein The processing module 240 may consist of one or more servers and/or general purpose computers, each having one or more computer processors associated therewith.

The processing module 240 may have a database 250 communicatively coupled thereto. The database 250 may contain data and information used by the system 200. For example, the database 250 may store account data for financial institution account holders. Additional information maybe contained therein related to the operation and administration of the system 200. The database 250 may include any suitable data structure to maintain the information and allow access and retrieval of the information. For example, the database may keep the data in an organized fashion. The database 250 may be a database, such as an Oracle database, a Microsoft SQL Server database, a DB2 database, a MySQL database, a Sybase database, an object oriented database, a hierarchical database, a flat database, and/or another type of database as may be known in the art that may be used to store and organize rule data as described herein.

The database 250 may be stored in any suitable storage device. The storage device may include multiple data storage devices. The multiple data storage devices may be operatively associated with the database 250. The storage may be local, remote, or a combination thereof with respect to the database. The database 250 may utilize a redundant array of disks (RAID), striped disks, hot spare disks, tape, disk, or other computer accessible storage In one or more embodiments, the storage may be a storage area network (SAN), an internet small computer systems interface (iSCSI) SAN, a Fiber Channel SAN, a common Internet File System (CIFS), network attached storage (NAS), or a network file system (NFS). The database may have back-up capability built-in. Communications with the database 250 may be over a network, such as the network 235, or communications may be over a direct connection between the database 250 and the processing module 240, as depicted in FIG. 2. Data may be transmitted and/or received from the database 250. Data transmission and receipt may utilize cabled network or telecom connections such as an Ethernet RJ15/Category 5 Ethernet connection, a fiber connection, a traditional phone wireline connection, a cable connection or other wired network connection. A wireless network may be used for the transmission and receipt of data.

The system 200 may have other systems 260 associated therewith. These other systems 260 may include the third party system(s) as described in FIG. 1. These third party systems may be remotely located from the processing module 240. Communications may occur over the network 215.

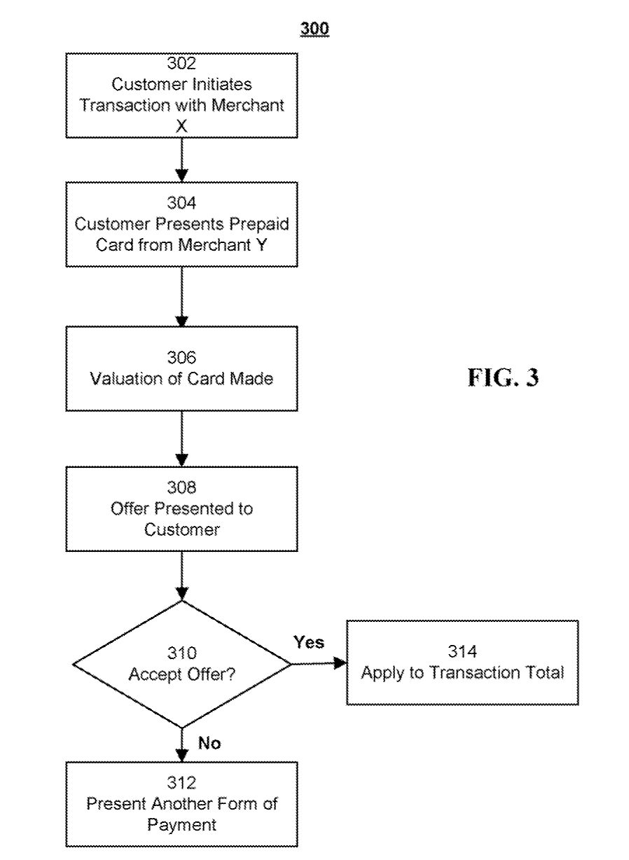

FIG. 3 depicts a flow chart of a method of exchanging a stored value card according to exemplary embodiments of the invention. Exemplary method 300 is provided by way of example, as there are a variety of ways to carry out the methods disclosed herein The method 300 may be executed or otherwise performed by one or a combination of various systems, such as a computer implemented system. Each block shown in FIG. 3 represents one or more processes, methods, and/or subroutines carried out in the exemplary method 300. Each block may have an associated processing machine or the blocks depicted may be carried out through one processor machine.

The method 300, according to exemplary embodiments, may be carried out on-line, that is, through a website over the Internet. It should be appreciated that other computer based networks may be used. For example, the method 300 may be carried out through a website over a computer based network associated with a financial institution.

At block 302, a customer initiates a transaction with a merchant X The customer may approach a merchant terminal at a check-out location at merchant X. The customer may desire to purchase goods and/or services from merchant X. The initiation of the transaction may be the customer at the check-out terminal and the merchant scanning or otherwise determining the amount of the transaction, such as the total price of the goods and/or services. The customer may then have to determine how to pay for the transaction. According to exemplary embodiments, the customer has one or more accounts with or is associated with a financial institution.

At block 304, the customer may present a prepaid card from merchant Y. The customer may present a prepaid card, gift card, or a stored value card that is associated with a different merchant than X. The prepaid card may be from merchant Y. Such a prepaid card may not typically be accepted for a transaction at merchant X.

According to exemplary embodiments, merchant X and Y may be associated with or partners with the financial institution. The merchants X and y may be participating merchants in a program with the financial institution.

As part of the presentation of the prepaid card, the customer may swipe the card or otherwise interact with the merchant terminal. The presentation may involve the transfer of account information from the card to the merchant terminal. The customer may be requested to enter certain data from the card into the merchant terminal. In some embodiments, the merchant may enter the data. Once swiped the information may be transmitted through a payment network along with the amount of the transaction.

The information, once input and/or selected, may then be transmitted to the financial institution for further processing. The information may be transmitted to a third party. In some embodiments, the information may be transmitted to both the financial institution and the third party. The information may be processed by the financial institution prior to transmission to the third party. In some embodiments, multiple third parties may be involved. For example, the information may be transmitted to more than one third party. The initial processing of the information may include a determination of the validity of the card, if the card is determined to not be valid, then the customer may be so informed and the transaction for the terminated with respect to the card usage.

The information required may be the card type, card name, card account number, and expiration date. This information is exemplary and other information may be required. The information may be obtained from the card.

At block 306, a value determination of the card is made. The value determination is the value the user will receive for the card and may apply to the transaction amount The value may be determined by the financial institution or by a third party. A combination of both may determine the value. The value may be based upon an exchange rate The exchange rate may be fixed or variable. For example, the card may have $50 of value which is exchanged at a 1:1 rate. Thus, the user would get $50 in the exchange. The exchange rate may be higher or lower than one. The exchange rate may be based on the type of currency associated with the card or the currency the exchange is being made for.

In some embodiments, the value determination may be made by a number of parties. Thus, more than one value determination may be made by the number of parties. The parties may be associated with or predetermined by the financial institution as participating in the method described herein. Different exchange rates may be used. For example, the each of the number of parties may produce a value determination. In this case of more than one value determination, the financial institution may receive these different value determinations The financial institution may then evaluate the value determinations and determine which one to present as the offer to the user. The financial institution may use different criteria to assess which one to present. For example, the value determination using the most favorable exchange rate may be used as the offer. Thus, this embodiment may be able to find the “best” offer to make to the user. This process of evaluating the value determinations may be done automatically using a computer which has a set of rules programmed to make the determination. The rules may be changed or updated as needed by the financial institution.

At block 308, the offer, which is the value determination, is presented to the customer. The offer may be presented through the merchant terminal.

At block 310, a decision is made to accept the offer. The user can make a decision on whether to accept the offer. The user may be presented with a total value they will receive from the exchange to apply to the transaction amount. The exchange rate may be displayed for the customer. The user may be presented with multiple offers as described above. As a part of acceptance of the value, the value of card is decreased accordingly. The financial institution may notify the appropriate entity or third party of the use of the card to facilitate this.

If the user declines the offer, at block 312 the user may be requested to provide another payment form for the transaction amount or to cancel the transaction.

If the user accepts the offer, at block 314 the value of the card is applied against the transaction total amount. It should be appreciated that in some cases a split tender transaction may be required to cover the full value of a transaction since the prepaid card may not have sufficient value thereon based on the conversion.

In some transactions, the prepaid card may have more determined value than the amount of the transaction. In such transactions, the determined value of the card presented may be set to be equivalent to the transaction amount. The card may then have value remaining which may be used for future transactions. If the determined value of the card is less than the transaction value, the entire determined value may be offered.

According to some embodiments, the customer may be able to specify a portion of the determined value to use for the transaction and conduct a split tender transaction for the remaining transaction amount.

Hereinafter, aspects of implementation of the inventions will be described. As described above, the method of the invention may be computer implemented as a system. The system of the invention or portions of the system of the invention may be in the form of a “processing machine,” for example. As used herein, the term “processing machine” is to be understood to include at least one processor that uses at least one memory The at least one memory stores a set of instructions. The instructions may be either permanently or temporarily stored in the memory or memories of the processing machine. The processor executes the instructions that are stored in the memory or memories in order to process data. The set of instructions may include various instructions that perform a particular task or tasks, such as those tasks described above in the flowcharts Such a set of instructions for performing a particular task may be characterized as a program, software program, or simply software.

The description of exemplary embodiments describes servers, portable electronic devices, and other computing devices that may include one or more modules, some of which are explicitly depicted in the figures, others are not. As used herein, the term “module” may be understood to refer to executable software, firmware, hardware, and/or various combinations thereof it is noted that the modules are exemplary. The modules may be combined, integrated, separated, and/or duplicated to support various applications. Also, a function described herein as being performed at a particular module may be performed at one or more other modules and/or by one or more other devices (e.g., servers) instead of or in addition to the function performed at the particular module. Further, the modules may be implemented across multiple devices and/or other components local or remote to one another. Additionally, the modules may be moved from one device and added to another device, and/or may be included in both devices. It is further noted that the software described herein may be tangibly embodied in one or more physical media, such as, but not limited to, a compact disc (CD), a digital versatile disc (DVD), a floppy disk, a hard drive, read only memory (ROM), random access memory (RAM), as well as other physical media capable of storing software, and/or combinations thereof. Moreover, the figures illustrate various components (e.g., servers, portable electronic devices, client devices, computers, etc.) separately. The functions described as being performed at various components may be performed at other components, and the various components may be combined and/or separated Other modifications also may be made.

According, to exemplary embodiments, the systems and methods may be computer implemented using one or more computers, incorporating computer processors. The computer implementation may include a combination. If software and hardware. The computers may communicate over a computer based network. The computers may have software installed thereon configured to execute the methods of the exemplary embodiments. The software may be in the form of modules designed to cause a computer processor to execute specific tasks. The computers may be configured with hardware to execute specific tasks. As should be appreciated, a variety of computer based configurations are possible.

The processing machine described above may also utilize any of a wide variety of other technologies including a special purpose computer, a computer system including a microcomputer, mini computer or mainframe for example, a programmed microprocessor, a micro-controller, a PICE (peripheral integrated circuit element), a CSIC (Customer Specific integrated Circuit) or ASIC (Application Specific Integrated Circuit) or other integrated circuit, a logic circuit, a digital signal processor, a programmable logic device such as a FPGA, PLD, PLA or PAL, or any other device or arrangement of devices for example capable of implementing the steps of the process of the invention.

It is appreciated that in order to practice the method of the invention as described above, it is not necessary that the processors and/or the memories of the processing machine be physically located in the same geographical place. For example, each of the processors and the memories and the data stores used in the invention may be located in geographically distinct locations and connected so as to communicate in any suitable manner. Additionally, it is appreciated that each of the processor and/or the memory and/or data stores may be composed of different physical pieces of equipment. Accordingly, it is not necessary that the processor be one single piece of equipment in one location and that the memory be another single piece of equipment in another location. For example, it is contemplated that the processor may be two or more pieces of equipment in two or more different physical locations. These two or more distinct pieces of equipment may be connected in any suitable manner. Additionally, the memory may include two or more portions of memory in two or more physical locations. Additionally, the data storage may include two or more components or two or more portions of memory in two or more physical locations.

To explain further, processing as described above is performed by various components and various memories. However, it is appreciated that the processing performed by two distinct components as described above may, in accordance with a further embodiment of the invention, be performed by a single component. Further, the processing performed by one distinct component as described above may be performed by two distinct components. In a similar manner, the memory storage performed by two distinct memory portions as described above may, in accordance with a further embodiment of the invention, be performed by a single memory portion. Further, the memory storage performed by one distinct memory portion as described above may be performed by two memory portions. It is also appreciated that the data storage performed by two distinct components as described above may, in accordance with a further embodiment of the invention, be performed by a single component. Further, the data storage performed by one distinct component as described above may be performed by two distinct components.

Further, various technologies may be used to provide communication between the various processors and/or memories, as well as to allow the processors and/or the memories of the invention to communicate with any other entity; e.g., so as to obtain further instructions or to access and use remote memory stores, for example. Such technologies used to provide such communication might include a network, such as a computer network, for example, the Internet, Intranet, Extranet, LAN, or any client server system that provides communication of any capacity or bandwidth, for example. Such communications technologies may use any suitable protocol such as TCP/IP, UDP, or OSI, for example. It should be appreciated that examples of computer networks used in the preceding description of exemplary embodiments, such as the Internet, are meant to be non-limiting and exemplary in nature.

As described above, a set of instructions is used in the processing of the invention The set of instructions may be in the form of a program or software. The software may be in the form of system software or application software, for example. The software might also be in the form of a collection of separate programs, a program module within a larger program, or a portion of a program module, for example. The software used might also include modular programming in the form of object oriented programming or any other suitable programming form The software tells the processing machine what to do with the data being processed.

Further, it is appreciated that the instructions or set of instructions used in the implementation and operation of the invention may be in a suitable form such that the processing machine may read the instructions. For example, the instructions that form a program may be in the form of a suitable programming language, which is converted to machine language or object code to allow the processor or processors to read the instructions. For example, written lines of programming code or source code, in a particular programming language, are converted to machine language using a compiler, assembler or interpreter. The machine language is binary coded machine instructions that are specific to a particular type of processing machine, e.g., to a particular type of computer, for example. The computer understands the machine language.

Any suitable programming language may be used in accordance with the various embodiments of the in vet on. Illustratively, the programming language used may include assembly language, Ada, APL, Basic, C, C+ , C#, COBOL, dBase, Forth, Fortran, Java, Modula-2, Pascal, Prolog, REXX, Ruby, Visual Basic, and/or JavaScript, for example. Further, it is not necessary that a single type of instructions or single programming language be utilized in conjunction with the operation of the system and method of the invention. Rather, any number of different programming languages may be utilized as is necessary or desirable.

Also, the instructions and/or data used in the practice of the invention may utilize any compression or encryption technique or algorithm, as may be desired. An encryption module might be used to encrypt data. Further, files or other data may be decrypted using a suitable decryption module, for example.

As described above, the invention may illustratively be embodied in the form of a processing machine, including a computer or computer system, for example, that includes at least one memory. It is to be appreciated that the set of instructions, e.g., the software for example, that enables the computer operating system to perform the operations described above may be contained on any of a wide variety of computer readable media, as desired. Further, the data for example processed by the set of instructions might also be contained on any of a wide variety of media or medium. For example, the particular medium, e.g., the memory in the processing machine, utilized to hold the set of instructions and/or the data used in the invention may take on any of a variety of physical forms or transmissions, for example. Illustratively, the medium may be in the form of paper, paper transparencies, a compact disk, a DVD, an integrated circuit, a hard disk, a floppy disk, an optical disk, a magnetic tape, a RAM, a ROM, a PROM, a EPROM, a wire, a cable, a fiber, communications channel, a satellite transmissions or other remote transmission, as well as any other medium or source of data that may be read by the processors of the invention.

Further, the memory or memories used in the processing machine that implements the invention may be in any of a wide variety of forms to allow the memory to hold instructions, data, or other information, as is desired. Thus, the memory might be in the form of a database to hold data. The database might use any desired arrangement of files such as a flat file arrangement or a relational database arrangement, for example.

In the system and method of the invention, a variety of “user interfaces” may be utilized to allow a user to interface with the processing machine or machines that are used to implement the invention. As used herein, a user interface includes any hardware, software, or combination of hardware and software used by the processing machine that allows a user to interact with the processing machine. A user interface may be in the form of a dialogue screen for example. A user interface may also include any of a mouse, touch screen, keyboard, voice reader, voice recognizer, dialogue screen, menu box, list, checkbox, toggle switch, a pushbutton or any other device that allows a user to receive information regarding the operation of the processing machine as it processes a set of instructions and/or provide the processing machine with information. Accordingly, the user interface is any device that provides communication between a user and a processing machine. The information provided by the user to the processing machine through the user interface may be in the form of a command, a selection of data, or some other input, for example.

As discussed above, a user interface is utilized by the processing machine that performs a set of instructions such that the processing machine processes data for a user. The user interface is typically used by the processing machine for interacting with a user either to convey information or receive information from the user. However, it should be appreciated that in accordance with some embodiments of the system and method of the invention, it is not necessary that a human user actually interact with a user interface used by the processing machine of the invention. Rather, it is contemplated that the user interface of the invention might interact, e.g., convey and receive information, with another processing machine, rather than a human user. Accordingly, the other processing machine might be characterized as a user. Further, it is contemplated that a user interface utilized in the system and method of the invention may interact partially with another processing machine or processing machines. While also interacting partially with a human user.

While the embodiments have been particularly shown and described within the framework of financial services and websites, it will be appreciated that variations and modifications may be effected by a person of ordinary skill in the art without departing from the scope of the invention. Furthermore, one of ordinary skill in the art will recognize that such processes and systems do not need to be restricted to the specific embodiments described herein. Other embodiments, combinations of the present embodiments, and uses and advantages of the present invention will be apparent to those skilled in the art from consideration of the specification and practice of the invention disclosed herein. The specification and examples should be considered exemplary.

1. A method, comprising:
receiving, electronically, a request, from a customer of a financial institution, to exchange a pre-paid card for funds corresponding to a determined value of the pre-paid card;
receiving from the customer data relating to the pre-paid card, wherein the pre-paid card is associated with a bankrupt or otherwise defunct merchant;
processing, by at least one computer processor, the request;
transmitting the request to a plurality of third parties;
determining, by each of the plurality of third parties, an initial value based on one or more specified exchange rates associated with each of the plurality of third parties, wherein the initial value is based on an agreement between the financial institution and the bankrupt or otherwise defunct merchant;
receiving, from each of the plurality of third parties, the initial value such that a plurality of initial values are received;
processing each of the plurality of initial values received;
applying one or more business rules to each of the plurality of the initial values received to evaluate which one of the initial values to offer the customer as a rule selected value of the pre-paid card in an offer, wherein the one or more business rules comprise determining the received initial value associated with the highest exchange rate;
providing, electronically, a plurality of offers to the customer, wherein each of the plurality of offers corresponds to at least one of the initial values or the rule selected value;
receiving a decision from the customer indicating one of the plurality of offers for acceptance;
selecting, upon acceptance of the offer, a determined value of the pre-paid card, wherein the determined value is the value corresponding to the accepted offer;
providing the determined value to the customer by depositing the determined value into an account designated by the customer; and
wherein the financial institution requires the customer to maintain a designated minimum balance in the designated account to cover recoupment of the provided value in the event the request is subsequently found to be fraudulent.

2. The method of claim 1, wherein the customer has one or more accounts with the financial institution.

3. The method of claim 1, further comprising:
receiving log-in information, associated with the customer, from a remote terminal.

4. The method of claim 3, wherein the log-in information is received from a website.

5. The method of claim 3, wherein the remote terminal is a computing device.

6. The method of claim 5, wherein the computing device comprises a portable electronic device.

7. The method of claim 6, wherein the portable electronic device comprises a smart phone or a tablet computing device.

8. The method of claim 3, wherein the remote terminal is a financial transaction device.

9. The method of claim 8, wherein the financial transaction device comprises an automated teller machine.

10. The method of claim 1, wherein the data comprises the pre-paid card account number.

11. (canceled)

12. (canceled)

13. The method of claim 1, wherein the pre-paid card is a gift card.

14. A system, comprising:
a processor; and
a memory comprising computer-readable instructions which when executed by the processor cause the processor to perform the steps comprising:
receiving a request, from a customer of a financial institution, to exchange a pre-paid card for funds corresponding to a determined value of the pre-paid card, wherein the pre-paid card is associated with a bankrupt or otherwise defunct merchant;
receiving from the customer data relating to the pre-paid card;
processing the request;
transmitting the request to a plurality of third parties;
receiving, from each of the plurality of third parties, an initial value that is determined by the third party based on one or more specified exchange rates associated with each of the plurality of third parties such that a plurality of initial values are received, wherein the initial value is based on an agreement between the financial institution and the bankrupt or otherwise defunct merchant;
processing each of the plurality of initial values received;
applying one or more business rules to each of the plurality of initial values received to evaluate which one of the plurality of initial values received to offer the customer as a rule selected value of the pre-paid card in an offer, wherein the one or more business rules comprise determining the received initial value associated with the highest exchange rate;
providing, electronically, a plurality of offers to the customer, wherein each of the plurality of offers corresponds to at least one of the initial values or the rule selected value;
receiving a determination from the customer indicating one of the plurality of offers for acceptance;
selecting, upon acceptance of the offer, a determined value of the pre-paid card, wherein the determined value is the value corresponding to the accepted offer;
providing the determined value to the customer by depositing the determined value into an account designated by the customer; and
wherein the financial institution requires the customer to maintain a designated minimum balance in the designated account to cover recoupment of the provided value in the event the request is subsequently found to be fraudulent.

15. The system of claim 14, wherein the customer has one or more accounts with the financial institution.

16. The system of claim 14, further comprising:
receiving log-in information, associated with the customer, from a remote terminal.

17. The system of claim 16, wherein the log-in information is received from a website.

18. The system of claim 16, wherein the remote terminal is a computing device.

19. The system of claim 18, wherein the computing device comprises a portable electronic device.

20. The system of claim 19, wherein the portable electronic device comprises a smart phone or a tablet computing device.

21. The system of claim 16, wherein the remote terminal is a financial transaction device.

22. The system of claim 21, wherein the financial transaction device comprises an automated teller machine.

23. The system of claim 14, wherein the data comprises the pre-paid card account number.

24. (canceled)

25. (canceled)

26. The system of claim 14, wherein the pre-paid card is a gift card.

27. A method, comprising:
receiving, electronically, a transaction request, from a first merchant to use a pre-paid card for a transaction wherein the pre-paid card is from a second merchant and the pre-paid card is presented for the transaction by a customer of a financial institution;
receiving data relating to the pre-paid card, wherein the pre-paid card is associated with a bankrupt or otherwise defunct merchant;
processing, by at least one computer processor, the data and the transaction request;
transmitting the request to a plurality of third parties;
determining, by each of the plurality of third parties, an initial value based on one or more specified exchange rates associated with each of the plurality of third parties, wherein the initial value is based on an agreement between the financial institution and the bankrupt or otherwise defunct merchant;
receiving, from each of the plurality of third parties, the initial value such that a plurality of initial values are received;
processing each of the plurality of initial values received;
applying one or more business rules to each of the plurality of initial values received to evaluate which one of the plurality of initial values to offer the customer as a rule selected value of the pre-paid card in an offer, wherein the one or more business rules comprise determining the received initial value associated with the highest exchange rate;
providing, electronically, a plurality of offers to the customer, through a merchant terminal, wherein each of the plurality of offers corresponds to at least one of the initial values or the rule selected value of the pre-paid card with regards to the transaction;
receiving a determination from the customer indicating one of the plurality of offers for acceptance;
selecting, upon acceptance of the offer, a determined value of the pre-paid card, wherein the determined value is the value corresponding to the accepted offer; and
applying the determined value against an amount of the transaction.

28. The method of claim 27, wherein the customer has one or more accounts with the financial institution and the financial institution requires the customer to maintain a designated minimum balance in at least one of the one or more accounts to cover recoupment of the provided value in the event the request is subsequently found to be fraudulent.

29. The method of claim 27, wherein the first merchant and the second merchant are in a partnership with the financial institution.

30. The method of claim 27, wherein the data comprises the pre-paid card account number.

31. (canceled)

32. (canceled)

33. The method of claim 27, wherein the pre-paid card is a gift card.

34. The method of claim 27, wherein the determined value is equivalent to the amount of the transaction.

35. The method of claim 27, wherein the determined value is less than the amount of the transaction.

36. The method of claim 35, further comprising:
receiving, from the first merchant, a split tender transaction request for the difference between the determined value and the amount of the transaction.

37. A system, comprising:
a processor; and
a memory comprising computer-readable instructions which when executed by the processor cause the processor to perform the steps comprising:
receiving a transaction request, from a first merchant to use a pre-paid card for a transaction wherein the pre-paid card is from a second merchant and the pre-paid card is presented for the transaction by a customer of a financial institution;
receiving data relating to the pre-paid card, wherein the pre-paid card is associated with a bankrupt or otherwise defunct merchant;
processing the data;
transmitting the request to a plurality of third parties;
receiving, from each of the plurality of third parties, an initial value that is determined by the third party based on one or more specified exchange rates associated with each of the plurality of third parties such that a plurality of initial values are received, wherein the initial value is based on an agreement between the financial institution and the bankrupt or otherwise defunct merchant;
processing each of the plurality of initial values received;
applying one or more business rules to each of the plurality of initial values received to evaluate which one of the plurality of initial values received to offer the customer as a rule selected value of the pre-paid card in an offer, wherein the one or more business rules comprise determining the received initial value associated with the highest exchange rate;
providing a plurality of offers to the customer, through a merchant terminal, wherein each of the plurality of offers corresponds to at least one of the initial values or the rule selected value of the pre-paid card with regards to the transaction;
receiving a determination from the customer indicating one of the plurality of offers for acceptance;
selecting, upon acceptance of the offer, a determined value of the pre-paid card, wherein the determined value is the value corresponding to the accepted offer; and
applying the determined value against an amount of the transaction.

38. The system of claim 37, wherein the customer has one or more accounts with the financial institution and the financial institution requires the customer to maintain a designated minimum balance in at least one of the one or more accounts to cover recoupment of the provided value in the event the request is subsequently found to be fraudulent.

39. The system of claim 37, wherein the first merchant and the second merchant are in a partnership with the financial institution.

40. The system of claim 37, wherein the data comprises the pre-paid card account number.

41. (canceled)

42. (canceled)

43. The system of claim 37, wherein the pre-paid card is a gift card.

44. The system of claim 37, wherein the determined value is equivalent to the amount of the transaction.

45. The system of claim 37, wherein the determined value is less than the amount of the transaction.

46. The system of claim 45, further comprising:
receiving, from the first merchant, a split tender transaction request for the difference between the determined value and the amount of the transaction.
